(19) United States
(12) Patent Application Publication
(10) Pub. No.: US 2026/0338920 A1
(43) Pub. Date: Oct. 29, 2026

(54) DISTANCE MEASUREMENT APPARATUS, PHOTODETECTION APPARATUS, AND SIGNAL PROCESSING APPARATUS

(71) Applicant: Sony Semiconductor Solutions Corporation, Kanagawa (JP)

(72) Inventor: Satoru HIGASHINO, Kanagawa (JP)

(73) Assignee: Sony Semiconductor Solutions Corporation, Kanagawa (JP)

(21) Appl. No.: 19/122,267

(22) PCT Filed: Sep. 19, 2023
(86) PCT No.: PCT/JP2023/033837

§ 371 Date: Apr. 18, 2025

(30) Foreign Application Priority Data
Oct. 25, 2022 (JP) 2022-170337

(51) Int. Cl. G01S 7/481; G01S 17/32

(52) U.S. Cl. CPC G01S 7/4816; G01S 17/32

(57) ABSTRACT

A distance measurement apparatus includes a light source unit, a detector, an AD converter, a signal processor, a storage, and a controller. The light source unit outputs an optical signal subjected to a frequency modulation. The detector detects a beat signal based on the optical signal and the optical signal delay. The AD converter samples the beat signal at each sampling point and performs an AD conversion. The signal processor generates a first signal on the basis of the beat signal converted into a digital signal. The first signal is regarding a correction amount of a frequency of the optical signal. The storage allows a plurality of first signals corresponding to a plurality of respective sampling points to be stored. The controller controls the frequency modulation of the optical signal on the basis of the first signal stored in the storage.

### TECHNICAL FIELD

The present disclosure relates to a distance measurement apparatus, a photodetection apparatus, and a signal processing apparatus.

### BACKGROUND ART

An FM-CW laser radar device has been proposed that corrects a nonlinear distortion of a frequency modulation characteristic of a transmission signal (PTL 1).

### CITATION LIST

### Patent Literature

PTL 1: Japanese Unexamined Patent Application Publication No. 2017-181269

### SUMMARY OF THE INVENTION

It is desirable that a distance measurement apparatus be improved in frequency modulation characteristic.

It is desired to provide a distance measurement apparatus that allows for an improvement in frequency modulation characteristic.

A distance measurement apparatus according to an embodiment of the present disclosure includes a light source unit, a detector, an AD converter, a signal processor, a storage, and a controller. The light source unit is configured to output an optical signal subjected to a frequency modulation. The detector is configured to detect a beat signal based on the optical signal and the optical signal delayed. The AD converter is configured to sample the beat signal at each of sampling points and to perform an AD conversion. The signal processor is configured to generate a first signal on the basis of the beat signal converted into a digital signal. The first signal is regarding a correction amount of a frequency of the optical signal. The storage is configured to allow a plurality of first signals corresponding to a plurality of respective sampling points to be stored in the storage. The controller is configured to control the frequency modulation of the optical signal on the basis of the first signal stored in the storage.

A photodetection apparatus according to an embodiment of the present disclosure includes a detector, an AD converter, a signal processor, a storage, and a controller. The detector is configured to detect a beat signal based on an optical signal and the optical signal delayed. The optical signal is outputted from a light source unit and subjected to a frequency modulation. The AD converter is configured to sample the beat signal at each of sampling points and to perform an AD conversion. The signal processor is configured to generate a first signal on the basis of the beat signal converted into a digital signal. The first signal is regarding a correction amount of a frequency of the optical signal. The storage is configured to allow a plurality of first signals corresponding to a plurality of respective sampling points to be stored in the storage. The controller is configured to control the frequency modulation of the optical signal on the basis of the first signal stored in the storage.

A signal processing apparatus according to an embodiment of the present disclosure includes a detector, an AD converter, a signal processor, a storage, and a controller. The detector is configured to detect a beat signal based on an optical signal and the optical signal delayed. The optical signal is outputted from a light source unit and subjected to a frequency modulation. The AD converter is configured to sample the beat signal at each of sampling points and to perform an AD conversion. The signal processor is configured to generate a first signal on the basis of the beat signal converted into a digital signal. The first signal is regarding a correction amount of a frequency of the optical signal. The storage is configured to allow a plurality of first signals corresponding to a plurality of respective sampling points to be stored in the storage. The controller is configured to output a signal to control the frequency modulation of the optical signal on the basis of the first signal stored in the storage.

### BRIEF DESCRIPTION OF THE DRAWINGS

FIG. 1 is a diagram illustrating an example of a schematic configuration of a distance measurement apparatus according to an embodiment of the present disclosure.

FIG. 2 is a diagram illustrating an example of signals to be generated by the distance measurement apparatus according to the embodiment of the present disclosure.

FIG. 3 is a diagram for describing an example of an oversampling process to be performed by the distance measurement apparatus according to the embodiment of the present disclosure.

FIG. 4 is a diagram illustrating an example of a beat signal and a reference signal of the distance measurement apparatus according to the embodiment of the present disclosure.

FIG. 5 is a diagram for describing a configuration example of a signal processor of the distance measurement apparatus according to the embodiment of the present disclosure.

FIG. 6 is a diagram for describing an example of signal processing to be performed by the signal processor of the distance measurement apparatus according to the embodiment of the present disclosure.

FIG. 7 is a diagram for describing an example of the signal processing to be performed by the signal processor of the distance measurement apparatus according to the embodiment of the present disclosure.

FIG. 8 is a diagram for describing an example of a process of detecting a difference in phase error, to be performed by the distance measurement apparatus according to the embodiment of the present disclosure.

FIG. 9 is a diagram for describing an example of a correction process to be performed by the distance measurement apparatus according to the embodiment of the present disclosure.

### MODES FOR CARRYING OUT THE INVENTION

In the following, an embodiment of the present disclosure will be described in detail with reference to the drawings. Note that the description will be given in the following order.
1. Embodiment
2. Modification Examples
3. Application Examples

### 1. Embodiment

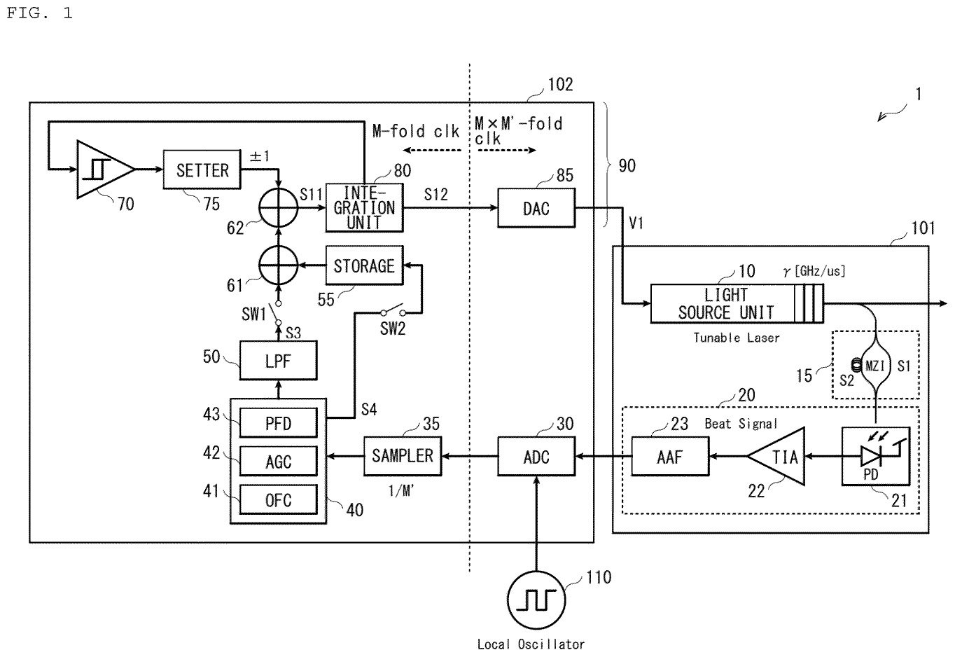

FIG. 1 is a diagram illustrating an example of a schematic configuration of a distance measurement apparatus according to the embodiment of the present disclosure. A distance measurement apparatus 1 is an apparatus configured to perform a distance measurement. The distance measurement apparatus 1 is an FMCW (Frequency Modulated Continuous Wave) distance measurement apparatus, and is applicable as an FMCW-LiDAR (Light Detection and Ranging).

Note that the distance measurement apparatus 1 that is a LiDAR apparatus may also be referred to as a laser radar apparatus. The distance measurement apparatus 1 may perform transmission and reception of an optical signal to be frequency-modulated modulation light, and may measure a distance to a measurement target, a speed of the measurement target, etc. The distance measurement apparatus 1 may be manufactured by, for example, using a silicon substrate, an SOI (Silicon On Insulator) substrate, or the like and using a silicon photonics (SiPh) technique.

The distance measurement apparatus 1 may irradiate, by a light source unit 10, the measurement target with frequency-modulated laser light, and may receive the laser light reflected by the measurement target and delayed. In the distance measurement apparatus 1, for example, an optical signal obtained by causing reference light branched (separated) from output light (irradiation light) of the light source unit 10 and reflected light reflected by the measurement target to interfere with each other is inputted to a detector 20. This allows for a detection of a beat signal having a frequency corresponding to a difference between a frequency of the reference light and a frequency of the reflected light. The beat signal generated by reception of the reflected light from the measurement target is a signal corresponding to the distance to the measurement target.

The distance measurement apparatus 1 may calculate a distance from the distance measurement apparatus 1 to the measurement target by analyzing the frequency of the beat signal (a beat frequency). In addition, the distance measurement apparatus 1 may calculate a speed (a relative speed) of the measurement target by using Doppler shift of light. For example, the distance measurement apparatus 1 calculates the speed of the measurement target on the basis of a beat frequency in a case where a frequency of laser light is increased over time, i.e., in a case of an up-chirp, and a beat frequency in a case where the frequency of the laser light is decreased over time, i.e., in a case of a down-chirp.

For example, the distance measurement apparatus 1 may output laser light to be an optical signal frequency-modulated into a triangle wave, and may calculate the speed of the measurement target, the distance to the measurement target, etc. by using the beat frequency of the beat signal of the case of each of the up-chirp and the down-chirp that are continuous with each other. The distance measurement apparatus 1 is configured to thus generate a signal (a chirp signal) in which a frequency continuously varies over time. The distance measurement apparatus 1 is a signal processing apparatus, and may also be referred to as a chirp generation apparatus (or a chirp signal generation apparatus).

Further, in the distance measurement apparatus 1 according to the present embodiment, a beat signal having a predetermined frequency is generated by an interference unit 15, the detector 20, etc., and the generated beat signal is used to correct a frequency modulation amount of an optical signal (laser light), which will be described later. This beat signal may also be referred to as a beat signal for correction.

The distance measurement apparatus 1 includes, as illustrated in FIG. 1, a first circuit block 101 and a second circuit block 102. The first circuit block 101 is configured to mainly include an analog circuit, and is configured to perform analog signal processing. The first circuit block 101 may also be referred to as an analog block. The second circuit block 102 is configured to mainly include a digital circuit, and is configured to perform digital signal processing. The second circuit block 102 may also be referred to as a digital block.

The first circuit block 101 includes the light source unit 10, the interference unit 15, and the detector 20. The light source unit 10 is configured to output a frequency-modulated optical signal. The light source unit 10 includes, for example, a tunable laser light source, and is configured to irradiate the measurement target with light. The light source unit 10 may generate frequency-modulated laser light, and may output the laser light. The light source unit 10 may also be referred to as a transmitter configured to transmit the optical signal.

The detector 20 includes a light reception section 21, and is configured to detect incident light. The light reception section 21 (a light reception device) includes, for example, a photodiode PD. The light reception section 21 may generate electric charge by receiving light and performing photoelectric conversion, and may output a current. For example, a signal corresponding to a photocurrent flowing through the light reception section 21 is generated in response to reception of an optical signal in which the laser light from the light source unit 10 and the delayed laser light are mixed (mixed), and the generated signal is outputted as a beat signal. The detector 20 is a reception unit configured to receive an optical signal, and is configured to convert the optical signal into an electric signal.

In an example illustrated in FIG. 1, the detector 20 includes an amplifier section 22 and a filter section 23. For example, the amplifier section 22 (an amplifier circuit) includes a transimpedance amplifier (TIA: Transimpedance Amplifier), and is configured to convert a current signal into a voltage signal. The amplifier section 22 may convert a current signal detected by the light reception section 21 into a voltage signal, and may output a beat signal that is the voltage signal to the filter section 23.

The filter section 23 is configured to selectively allow a signal in a predetermined frequency band to pass therethrough. The filter section 23 includes, for example, an anti-aliasing filter (AAF: Anti-Aliasing Filter). The filter section 23 is configured to perform a process of removing a signal component in an unnecessary band, out of the beat signal inputted from the amplifier section 22.

The interference unit 15 is configured to cause the laser light from the light source unit 10 and the delayed laser light to interfere with each other, and to output the interfered light (interference light). The interference unit 15 may output, to the light reception section 21 of the detector 20, an optical signal in which a plurality of optical signals is combined (coupled). The interference unit 15 may include, for example, a Mach-Zehnder interferometer (MZI: Mach-Zehnder Interferometer).

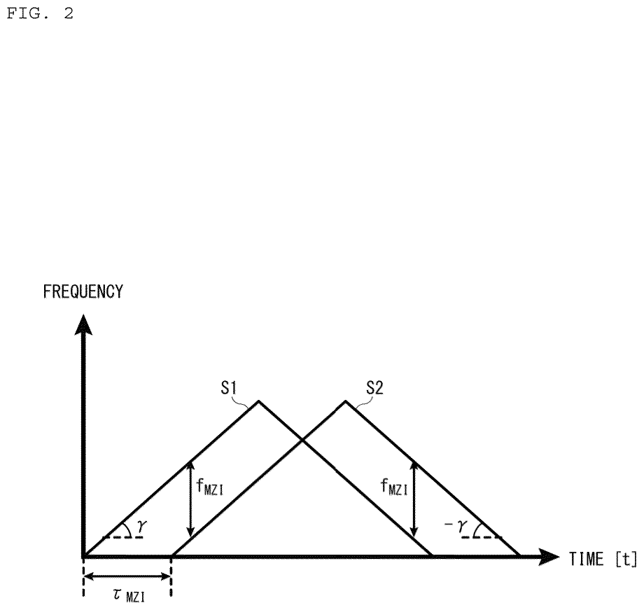

FIG. 2 is a diagram illustrating an example of signals to be generated by the distance measurement apparatus according to the embodiment. In FIG. 2, a vertical axis represents a frequency of a chirp signal, and a horizontal axis represents time. FIG. 2 illustrates an optical signal S1 that is the laser light from the light source unit 10, and an optical signal S2 that is laser light resulting from delaying the foregoing laser light by τ_{MZI}. The τ_{MZI} is a delay time (a delay amount). The interference unit 15 outputs, to the light reception section 21 of the detector 20, interference light generated by mixing the optical signal S1 and the optical signal S2 that are chirp signals.

The detector 20 may receive, by the light reception section 21, the interference light from the interference unit 15, and may generate the beat signal and output the beat signal as described above. The beat signal generated by receiving the interference light from the interference unit 15 is a signal having a frequency corresponding to a difference between a frequency of the optical signal S1 and a frequency of the optical signal S2. For example, where a chirp rate of the laser light is γ (for example, in unit of GHz/us), a frequency f_{MZI} of the beat signal is represented by γ×τ_{MZI} with use of the delay time τ_{MZI}. The distance measurement apparatus 1 is configured to correct a frequency modulation amount of the optical signal with use of the beat signal having the frequency f_{MZI}.

The second circuit block 102 includes an AD converter 30, a sampler 35, a signal processor 40, a filter unit 50, a storage 55, switches SW1 and SW2, and a controller 90. Further, as illustrated in FIG. 1, the distance measurement apparatus 1 includes an oscillation unit 110. The oscillation unit 110 (an oscillation circuit) is a local oscillator (Local Oscillator), for example. The oscillation unit 110 is configured to output a signal (referred to as a local signal LO1) having a frequency f_{LO1}.

The oscillation unit 110 may generate the local signal LO1 having a frequency higher than the frequency of the beat signal, for example, a frequency of integral multiple (multiple) of the frequency of the beat signal, and may output the generated local signal LO1 to the AD converter 30, a DA converter 85, etc. The frequency f_{LO1} of the local signal LO1 is, for example, M×M′×γ×τ_{MZI}. For example, M=16 and M′=20. In this case, the frequency f_{LO1} is a frequency resulting from multiplying the frequency f_{MZI} (=γ×τ_{MZI}) of the beat signal by 16×20.

In addition, the oscillation unit 110 is configured to output a signal (referred to as a local signal LO2) having a frequency f_{LO2} (=M×γ×τ_{MZI}) lower than the frequency f_{LO1} (=M×M′×γ×τ_{MZI}). The frequency f_{LO2} is a frequency resulting from multiplying the frequency f_{LO1} by 1/M′ (=1/20).

In the example illustrated in FIG. 1, the oscillation unit 110 supplies the local signal LO1 having the frequency f_{LO1} to the AD converter 30, the DA converter 85, etc. In addition, the oscillation unit 110 supplies the local signal LO2 having the frequency f_{LO2} to the sampler 35, the signal processor 40, an integration unit 80, etc. An AD conversion process by the AD converter 30 and a DA conversion process by the DA converter 85 are allowed to be performed in synchronization with the local signal LO1. A digital signal process by the signal processor 40, the integration unit 80, etc. is allowed to be performed in synchronization with the local signal LO2.

The AD converter 30 is configured to convert an inputted analog signal into a digital signal. The AD converter 30 is an ADC (Analog to Digital Converter). The AD converter 30 receives the beat signal from the detector 20, and receives the local signal LO1 as a clock signal from the oscillation unit 110. The AD converter 30 may sample the beat signal in accordance with the local signal LO1, and may convert the beat signal, which is an analog signal, into a digital signal.

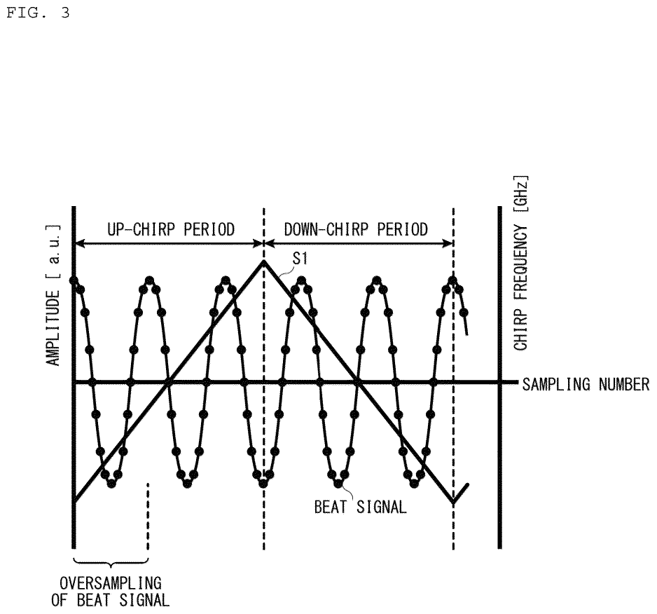

FIG. 3 is a diagram for describing an example of an oversampling process to be performed by the distance measurement apparatus according to the embodiment. FIG. 3 illustrates, on the same time axis, the frequency (a chirp frequency) of the optical signal S1 that is the chirp signal described above and an amplitude (a signal level) of the beat signal inputted to the AD converter 30. Note that in FIG. 3, the time axis on a horizontal axis is represented by a sampling number.

As in an example illustrated in FIG. 3, the beat signal has the frequency corresponding to a frequency difference between the optical signal S1 and the optical signal S2. The AD converter 30 performs the AD conversion process on the beat signal in a chirp period (in FIG. 3, an up-chirp period and a down-chirp period) that is a modulation period in which the laser light is frequency-modulated.

The AD converter 30 samples the beat signal at the frequency f_{LO1} of the local signal LO1, and outputs a digital signal at each of sampling points. In this case, the AD converter 30 samples the beat signal in synchronization with the local signal LO1 having the frequency f_{LO1} (=M×M′×γ×τ_{MZI}) that is a sampling frequency.

The AD converter 30 samples the beat signal and converts the beat signal into a digital signal at M×M′ (16×20) points in each period of the beat signal (note that FIG. 3 illustrates only 16 sampling points in each period). The AD converter 30 thus oversamples the beat signal at the frequency f_{LO1}, and outputs, to the sampler 35, the beat signal, at each of the sampling points, converted into a digital signal.

The sampler 35 is a downsampling unit, and is configured to downsample an inputted signal. The sampler 35 receives the beat signal at each of the sampling points outputted from the AD converter 30. In addition, the sampler 35 receives, as a clock signal, the local signal LO2 having the frequency f_{LO2} lower than the frequency f_{LO1} from the oscillation unit 110.

The sampler 35 downsamples the beat signal at the frequency f_{LO2} of the local signal LO2, and outputs the downsampled beat signal. In this case, for example, the sampler 35 performs a decimation (decimation) process on the beat signal outputted from the AD converter 30, and outputs a digital signal at each of the sampling points to the signal processor 40.

The signal processor 40 is configured to perform signal processing by using an inputted signal. The signal processor 40 includes a circuit that performs various kinds of signal processing on the beat signal. The signal processor 40 (a signal processing circuit) includes, for example, a plurality of logic circuits including, without limitation, a flip-flop circuit, an adder circuit, and a multiplier circuit. The signal processor 40 may perform, for example, various kinds of signal processing including, without limitation, a phase detection process and a reference signal generation process, which will be described later.

In the example illustrated in FIG. 1, the signal processor 40 includes a phase comparison section 43. The phase comparison section 43 is a phase comparator (PFD: Phase Frequency Detector), and is configured to compare phases (or frequencies) of signals. The phase comparison section 43 receives, for example, the beat signal downsampled by the sampler 35.

The filter unit 50 is a low pass filter (LPF: Low Pass Filter), and is configured to selectively allow a signal in a predetermined frequency band to pass therethrough. Note that the signal processor 40 may include the filter unit 50. Further, the signal processor 40 may include the storage 55 and an adder 61.

For example, the signal processor 40 compares the beat signal and the reference signal by the phase comparison section 43 (a phase comparison circuit), generates a signal (a correction signal S3) regarding a correction amount of the frequency of the optical signal (the laser light), and outputs the generated signal. Further, the signal processor 40 generates a signal (a correction signal S4) regarding a correction amount of the frequency of the optical signal at the sampling point described above, and stores the generated signal in the storage 55.

The distance measurement apparatus 1 may perform an OPLL (Optical Phase Locked Loop) operation with use of the correction signal S3, and may perform a pre-distortion operation with use of the correction signal S4 stored in the storage 55, which will be described later. In the distance measurement apparatus 1, for example, in a case where the OPLL operation is performed, the switch SW1 is turned on, and in a case where the pre-distortion operation is performed, the switch SW2 is turned on.

The storage 55 includes a plurality of memories (memory cells). The storage 55 (a storage circuit) is configured to allow the correction signal S4 to be stored therein. The signal processor 40 may control, via the switch SW2 illustrated in FIG. 1, writing of data to the storage 55 and reading of data from the storage 55. A plurality of correction signals S4 corresponding to the plurality of respective sampling points is stored in the storage 55.

The controller 90 illustrated in FIG. 1 is configured to control the light source unit 10 by supplying, to the light source unit 10, a signal to control the light source unit 10. The controller 90 is configured to control a frequency modulation of the optical signal of the light source unit 10. For example, the controller 90 generates a voltage signal V1 regarding the frequency modulation amount of the laser light of the light source unit 10, and outputs the generated voltage signal V1 to the light source unit 10. The controller 90 may control the frequency, the chirp rate, etc. of the laser light that the light source unit 10 outputs, by controlling the voltage signal V1 to be supplied to the light source unit 10.

In the example illustrated in FIG. 1, the controller 90 includes a comparison unit 70, a setter 75, an adder 62, the integration unit 80, and the DA converter 85. The comparison unit 70 includes a comparator circuit, for example, a hysteresis comparator. The comparison unit 70 receives an output signal of the integration unit 80, for example, a signal based on an integral value. For example, the comparison unit 70 compares a signal indicating the integral value obtained by the integration unit 80 and a signal indicating a reference value, and outputs an output signal that is a comparison result to the setter 75.

The signal to be outputted from the comparison unit 70 is a signal regarding a switching timing of the chirp signal, and is, for example, a signal indicating a switching timing of an up chirp and a down chirp. The output signal of the comparison unit 70 may also be referred to as a signal indicating a start or an end of an up chirp (or a down chirp).

The setter 75 is configured to set an up chirp (or a down chirp) in the light source unit 10. The setter 75 may also be referred to as a chirp setter (or a ramp setter) configured to set a chirp direction of the optical signal. For example, on the basis of the output signal of the comparison unit 70, the setter 75 outputs, to the adder 62, a signal having a signal value based on the comparison result obtained by the comparison unit 70, as a signal indicating an up chirp (or a down chirp). The setter 75 outputs, for example, a signal indicating +1 for a case of the up chirp, and outputs, for example, a signal indicating −1 for a case of the down chirp.

The integration unit 80 is configured to output a digital signal having a value that changes for each predetermined time interval (period). The integration unit 80 receives a signal S11 via the adder 62 (an adder circuit). The signal S11 has a value based on a signal value (+1 or −1) of the output signal of the setter 75. For example, the integration unit 80 (an integral circuit) may generate a signal S12 in synchronization with the local signal LO2 having the frequency f_{LO2} (=M×γ×τ_{MZI}), and may output the generated signal S12 to the DA converter 85. The signal S12 is a signal having a value that increases over time, or a signal having a value that decreases over time.

The signal S12 to be outputted from the integration unit 80 is, for example, a signal that varies, in synchronization with an edge of the local signal LO2, by a value based on the signal S11 inputted to the integration unit 80. For example, the integration unit 80 outputs the signal S12 that monotonically increases for the case of the up chirp, and outputs the signal S12 that monotonically decreases for the case of the down chirp.

The DA converter 85 is configured to convert an inputted digital signal into an analog signal. The DA converter 85 is a DAC (Digital to Analog Converter). The DA converter 85 receives the signal S12 from the integration unit 80, and receives the local signal LO1 as a clock signal from the oscillation unit 110. The DA converter 85 may convert the signal S12, which is a digital signal, into an analog signal in accordance with the local signal LO1.

The DA converter 85 generates the voltage signal V1 by converting the signal S12 into an analog signal in synchronization with the frequency f_{LO1} of the local signal LO1, and outputs the generated voltage signal V1 to the light source unit 10. The voltage signal V1 to be supplied to the light source unit 10 is a signal (a ramp signal) that monotonically increases or monotonically decreases by a value corresponding to the signal S11 inputted to the integration unit 80. The controller 90 may control the frequency modulation of the laser light of the light source unit 10 by supplying the voltage signal V1 to the light source unit 10.

The signal processor 40 of the distance measurement apparatus 1 is configured to generate, as the correction signal S3, a signal based on a difference between the beat signal and a base signal. For example, the signal processor 40 may detect, as a phase error, the difference between the beat signal and the base signal on the basis of the comparison between the beat signal and the base signal performed by the phase comparison section 43, and may generate, as the correction signal S3, a signal regarding a magnitude of the phase error.

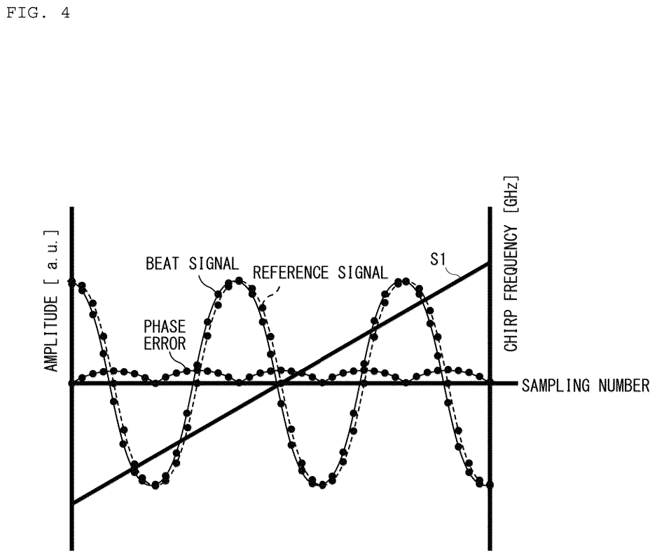

FIG. 4 illustrates an example of the beat signal and the reference signal of the distance measurement apparatus according to the embodiment. FIG. 4 illustrates, on the same time axis, the frequency of the optical signal S1 as the chirp signal, respective amplitudes (respective signal levels) of the beat signal and the reference signal, and the phase error that is the difference between the beat signal and the reference signal. Note that in FIG. 4, the time axis on the horizontal axis is represented by the sampling number. The reference signal indicated by a dashed-line waveform represents an ideal signal having the frequency f_{MZI} assumed in a case where the frequency modulation characteristic of the optical signal is linear.

As in the example illustrated in FIG. 4, the signal processor 40 may calculate the difference between the beat signal and the reference signal as the phase error. The signal processor 40 generates, as the correction signal S3, a signal indicating the magnitude of the calculated phase error. The signal processor 40 outputs the generated correction signal S3 to the adder 61 via the filter unit 50 and the switch SW1 illustrated in FIG. 1.

The adder 61 and the adder 62 are each configured to perform an addition process of signals. For example, in a case of the OPLL operation, the adder 61 outputs the correction signal S3 received from the signal processor 40 to the adder 62, and in a case of the pre-distortion operation, the adder 61 outputs the correction signal S4 received from the storage 55 to the adder 62. Note that the adder 61 may output, to the adder 62, a signal in which the correction signal S3 and the correction signal S4 are added up.

The adder 62 adds up the value (+1 or −1) of the output signal of the setter 75 and the value of the correction signal S3, and generates the signal S11 that is a digital signal indicating the added value. Addition of the correction signal S3 allows for generation of the signal S1 corrected on the basis of the phase error between the beat signal and the reference signal. The signal S12 generated with use of the corrected signal S1 is thus outputted to the DA converter 85. The DA converter 85 converts, into an analog signal, the signal S12 adjusted on the basis of the detected phase error, and outputs the generated voltage signal V1 to the light source unit 10. The light source unit 10 performs the frequency modulation of the optical signal, which is the laser light, on the basis of the voltage signal V1.

This allows the distance measurement apparatus 1 to perform a feedback to achieve a stable state (a locked state) in which the phase error is decreased, and to perform the OPLL operation. In the distance measurement apparatus 1, the voltage signal V1 so varies on the basis of the correction signal S3 as to decrease the phase difference between the beat signal and the reference signal, and the frequency modulation amount of the optical signal of the light source unit 10 is adjusted. It is possible to so correct the frequency modulation amount of the optical signal as to allow the frequency of the optical signal to vary continuously and linearly. This makes it possible to suppress degradation of the frequency modulation characteristic of the optical signal and to thus improve distance measurement accuracy.

Depending on the magnitude of the frequency f_{MZI} of the beat signal, the sampling points of the beat signal can decrease in number, which can make it difficult to perform a tracking operation by the PLL. In particular, in a case where the distance measurement apparatus 1 manufactured by using the SiPh technique is applied to a distance measurement apparatus to be mounted on a vehicle, it can be difficult to achieve a stable PLL operation. To address this, the distance measurement apparatus 1 according to the present embodiment performs the OPLL operation by using the beat signal oversampled at the frequency of integral multiple (multiple) of the frequency of the beat signal. This makes it possible to prevent the tracking operation by the PLL from being inappropriately performed due to the reduced sampling points. It is possible to suppress degradation of distance measurement performance.

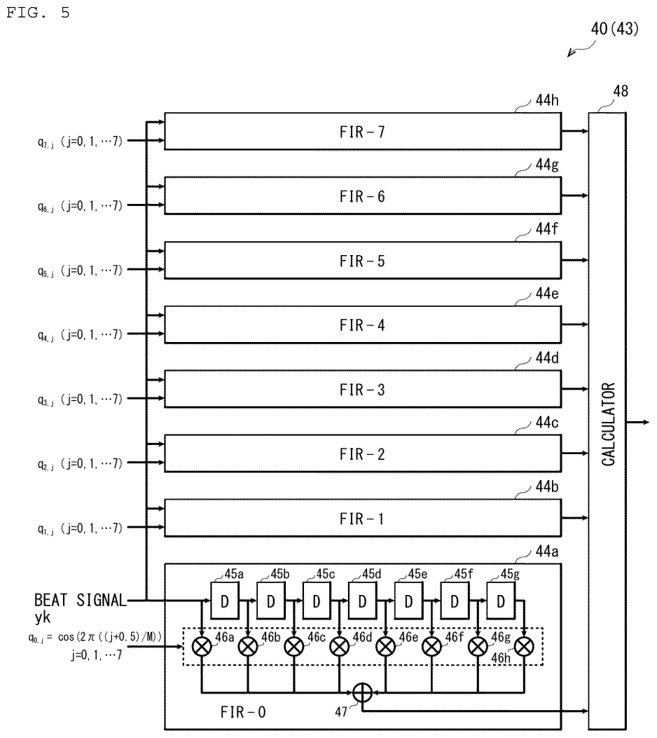

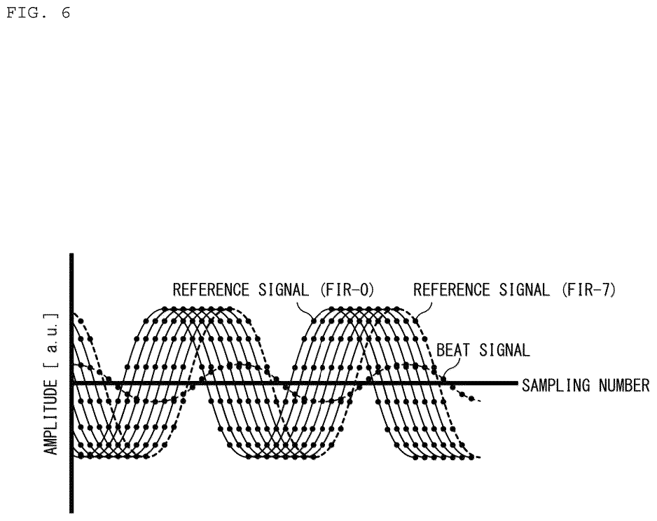

FIG. 5 is a diagram for describing a configuration example of a signal processor of the distance measurement apparatus according to the embodiment. FIG. 6 is a diagram for describing an example of signal processing to be performed by the signal processor of the distance measurement apparatus. The signal processor 40 is configured to generate the above-described reference signal on the basis of the beat signal at each of the sampling points.

The phase comparison section 43 of the signal processor 40 includes a plurality of FIR filters 44 (Finite Impulse Response) and a calculator 48, and is configured to generate the reference signal. The signal processor 40 has, for example, an M/2-phase FIR structure. In the example illustrated in FIG. 5, the signal processor 40 includes M (=16)/2=8 FIR filters, i.e., FIR filter 44a to FIR filter 44h (FIR-0 to FIR-7). The eight FIR filters 44a to 44h are disposed in parallel.

Each of the FIR filters 44 (the FIR filters 44a to 44h) includes, for example, a plurality of flip-flops 45 (in FIG. 5, flip-flops 45a to 45g), a plurality of multipliers 46 (in FIG. 45, multipliers 46a to 46h), and an adder 47. Each of the FIR filters 44a to 44h receives, for example, the beat signal at each of the sampling points from the sampler 35. In addition, each of the FIR filters 44 receives a coefficient q_{i,j} represented by the following Expression (1) as a coefficient of the FIR filter 44, as illustrated in FIG. 5.

$$[ Math . 1 ]$$

$${q}_{i , j} = cos \{ 2 π ( \frac{i + j + 0.5}{M} ) \} \qquad ( 1 )$$

Note that in Expression (1), i is the number of the FIR filter 44. In the example illustrated in FIG. 5, i=0 to 7 respectively correspond to the FIR filters 44a to 44h (FIR-0 to FIR-7). In addition, j is a tap-number index and is the number of the multiplier 46 in the FIR filter 44. In the example illustrated in FIG. 5, j=0 to 7 respectively correspond to the multipliers 46a to 46h.

The FIR filter 44 of the signal processor 40 receives the coefficient represented by Expression (1), as described above. For example, a coefficient q_{0,0} in a case where i=0 and j=0 in Expression (1) is set to a filter coefficient of the multiplier 46a of the FIR filter 44a illustrated in FIG. 5. In addition, for example, a coefficient q_{0,1} in a case where i=0 and j=1 in Expression (1) is set to a filter coefficient of the multiplier 46b of the FIR filter 44a.

Where the beat signal at a time k is represented by yk, in a case where the beat signal yk is inputted to the FIR filters 44a to 44h, the signal processor 40 may perform, by the FIR filters 44a to 44h, a convolution calculation represented by the following Expression (2). The time k corresponds to a timing at the sampling point.

$$[ Math . 2 ]$$

$${c}_{i , j} = {\sum }_{j = 0}^{\frac{M}{2} - 1} {q}_{i , j} \cdot {y}_{k - \frac{M}{2} - 1 + j} \qquad ( 2 )$$

FIG. 6 illustrates a waveform of the beat signal yk and respective waveforms of signals outputted from the FIR filters 44a to 44h. The FIR filters 44a to 44h each perform, by the flip-flops 45, the multipliers 46, the adder 47, etc., the foregoing calculation process represented by Expression (2). The FIR filters 44a to 44h thereby output eight reference signals (a reference signal (FIR-0) to a reference signal (FIR-7)) as illustrated in FIG. 6. The reference signals are each a signal indicating a cross-correlation value c_{i,j}. In other words, the FIR filters 44a to 44h generate the respective reference signals of eight phases that are different from each other in phase, and output the respective reference signals.

The calculator 48 of the signal processor 40 compares the reference signal outputted from each of the FIR filters 44 and the beat signal with each other, and determines (sets) the reference signal to be used in the calculation of the phase error described above. For example, the calculator 48 compares a peak value of the beat signal and a peak value of each of the eight output signals from the FIR filters 44a to 44h with each other. On the basis of a result of the comparison between the peak values, the calculator 48 selects the reference signal closest to the beat signal out of the eight reference signals.

In the example illustrated in FIG. 6, out of the eight reference signals, the reference signal (the reference signal (FIR-7)), indicated by a dashed line, generated by the FIR filter 44h is the reference signal closest to the beat signal, and is selected as the reference signal to be used in the calculation of the phase error. The calculator 48 may detect the phase error as described above by using the selected reference signal and the beat signal, and may generate the correction signal S3. It is thus possible for the distance measurement apparatus 1 according to the present embodiment to generate the correction signal S3 by acquiring an appropriate reference signal for the beat signal, and to control the frequency modulation amount.

Note that in a case where a peak value of the cross-correlation value ci varies depending on time, it can be difficult to perform a peak detection. To address this, the calculator 48 of the signal processor 40 may detect a zero-crossing point, i.e., a point at which the sign changes, may estimate a peak position by using the zero-crossing point, and may generate the reference signal.

For example, in a case where an n-th autocorrelation value out of the respective values of the sampling points of the reference signal is a negative edge (transition from positive (+1) to negative (−1)) at a certain time k, the peak position is determined to be a position M/4 (=4) clocks before the n-th position by using 1=(n−M/4, M). Note that 1 is a correlation phase, and mod (*, M) is a modulo function (an operator) indicating a positive remainder of a division by an integer M.

Further, in a case where the n-th autocorrelation value out of the respective values of the sampling points of the reference signal is a positive edge (transition from negative (−1) to positive (+1)) at the certain time k, the peak position is determinable by using 1=(n−M/4+M/2, M). A reference waveform rₗ in these cases is representable by the following Expression (3).

$$[ Math . 3 ]$$

$${r}_{l} = cos \{ 2 π ( \frac{l}{M} ) \} \qquad ( 3 )$$

With use of the foregoing Expression (3), a phase error pk is obtainable by the following Expression (4) in a case where 1≤M/2, and is obtainable by the following Expression (5) in a case where 1>M/2.

$$[ Math . 4 ]$$

$$pk = yk - rl \qquad ( 4 )$$

$$pk = - ( yk - rl ) \qquad ( 5 )$$

The reference signal obtainable by the foregoing Expression (2), (4), or (5) is determinable by using a correlation value that is a result of a convolution calculation of the beat signal from the past to the present accumulated in the FIR filter 44. This makes it possible to avoid occurrence of a pipeline stall. It is possible to suppress a decrease in phase margin caused by an increase in PLL loop delay.

As in the example illustrated in FIG. 1, the signal processor 40 may include an offset corrector 41 and a gain corrector 42. The offset corrector 41 is configured to perform an offset correction of the beat signal. The offset corrector 41 is an offset cancel circuit (OFC). Where the beat signal is b_k, a signal b′_k after the offset correction is, for example, representable by the following Expressions (6) and (7).

$$[ Math . 5 ]$$

$${ofs}_{k + 1} = {ofs}_{k} + α \cdot ( {b}_{k}^{′} - rl ) \qquad ( 6 )$$

$${b}_{k + 1}^{′} = {b}_{k}^{′} - {ofs}_{k} \qquad ( 7 )$$

Note that α is an updating coefficient of the offset correction. It is possible for the offset corrector 41 to cancel the offset of the beat signal by performing the offset correction represented by Expressions (6) and (7).

The gain corrector 42 is configured to perform a gain correction of the beat signal. The gain corrector 42 is an AGC (Auto Gain Control) circuit. For example, the gain corrector 42 may perform a gain correction represented by the following Expressions (8), (9), and (10) on the signal b′_k outputted from the offset corrector 41, and may output a signal yk that is an output signal represented by Expression (11). Note that β is an updating coefficient of the gain correction.

$$[ Math . 6 ]$$

$$\begin{matrix}{Eg}_{k} = {b}_{k}^{′} - rl & ( {b}_{k}^{′} \geq 0 )\end{matrix} \qquad ( 8 )$$

$$\begin{matrix}{Eg}_{k} = - ( {b}_{k}^{′} - rl ) & ( {b}_{k}^{′} < 0 )\end{matrix} \qquad ( 9 )$$

$${g}_{k + 1} = {g}_{k} - β \cdot {Eg}_{k} \qquad ( 10 )$$

$$yk = {g}_{k} \cdot {b}_{k}^{′} \qquad ( 11 )$$

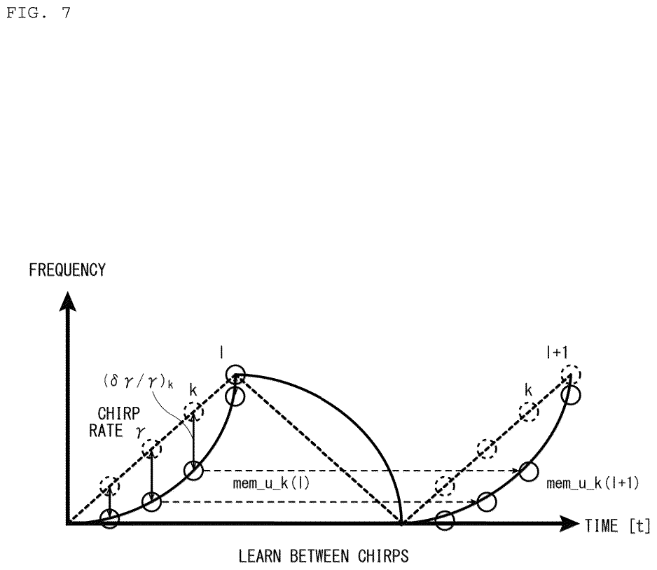

FIG. 7 is a diagram for describing an example of signal processing to be performed by the signal processor of the distance measurement apparatus according to the embodiment. The signal processor 40 is configured to generate the correction signal S4 regarding the correction amount of the frequency for each of the sampling points. The signal processor 40 generates a plurality of correction signals S4 corresponding to the plurality of respective sampling points on the basis of the beat signals at the respective sampling points, and stores the generated correction signals S4 in the storage 55.

The storage 55 includes memories corresponding in number to the plurality of sampling points. In the storage 55, the sampling point and the correction signal S4 indicating a correction value at that sampling point are associated with each other, and the sampling point and the correction signal S4 associated with each other are stored in the memory corresponding to that sampling point.

For example, as schematically illustrated in FIG. 7, the signal processor 40 repeatedly performs, for each chirp period, a comparison between the beat signal in one up-chirp period and the beat signal in the next up-chirp period. The signal processor 40 thus determines an error in the chirp rate, and learns a correction amount of the chirp rate. In addition, the signal processor 40 repeatedly performs, for each chirp period, a comparison between the beat signal in one down-chirp period and the beat signal in the next down-chirp period to learn the correction amount of the chirp rate.

The signal processor 40 thus detects the phase error of the beat signal by the phase comparison section 43, the calculator 48, etc., and stores the correction signal S4 in the storage 55. The correction signal S4 to be stored in the storage 55 is updated on the basis of the phase error detected for each of the sampling points. It is thus possible to learn the correction amount of the chirp rate. It is possible for the distance measurement apparatus 1 to perform the pre-distortion operation by a memory-learning-type ILC (Iterative Learning control).

An error βγ/γₖ of the chirp rate at the time k is representable by the following Expression (12). Note that Ts is a sampling period of the beat signal. Note that δTk is an error of the sampling period at the time k.

$$[ Math . 7 ]$$

$$\begin{matrix}\frac{δγ}{{γ}_{k}} = \frac{δ f}{{f}_{k}} \\ = {T}_{S} \cdot ( \frac{1}{{T}_{S} - δ {T}_{k - 1}} - \frac{1}{{T}_{S} - δ {T}_{k}} ) \\ = \frac{1}{1 + ( \frac{δ {T}_{k - 1}}{{T}_{S}} )} - \frac{1}{1 + ( \frac{δ {T}_{k}}{{T}_{S}} )}\end{matrix} \qquad ( 12 )$$

Further, the following Expression (13) is obtainable by Expression (12) and first-order Taylor approximation. As expressed in Expression (13), the error δγ/γₖ of the chirp rate is representable by a difference between a phase error pe_k at the time k and a phase error pe_(k−1) at a time (k−1) that is a previous time.

$$[ Math . 8 ]$$

$$\frac{δ γ}{{γ}_{k}} ≃ - ( \frac{δ {T}_{k - 1}}{{T}_{S}} ) + ( \frac{δ {T}_{k}}{{T}_{S}} ) = - ( {pe}_{k - 1} - {pe}_{k} ) \qquad ( 13 )$$

As expressed in the foregoing Expressions (12) and (13), the error δγ/γₖ of the chirp rate is representable by the frequency error, the difference between the phase errors, or the like. For example, the signal processor 40 may generate, as the correction signal S4, a signal indicating the frequency error of the beat signal, and may store the correction signal S4 generated for each of the sampling points in the storage 55. Further, for example, the signal processor 40 may generate, as the correction signal S4, a signal indicating a difference between respective phase errors at two sampling points, and may store the correction signal S4 generated for each of the sampling points in the storage 55.

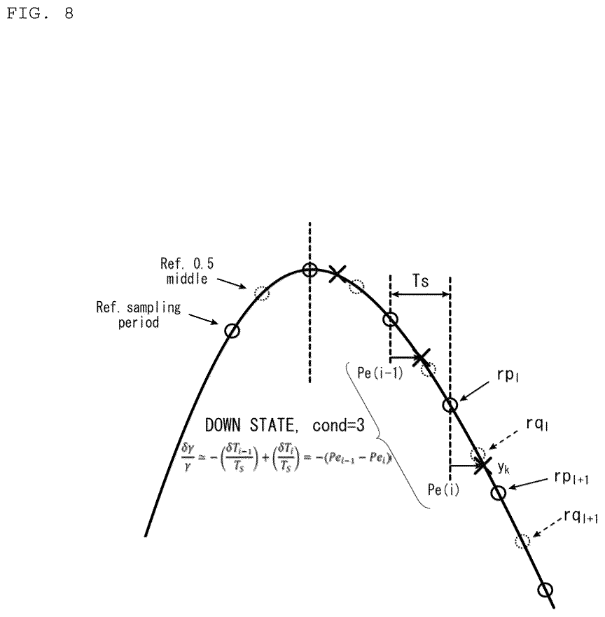

FIG. 8 is a diagram for describing an example of a process of detecting a difference between phase errors, to be performed by the signal processor of the distance measurement apparatus according to the embodiment. Note that in FIG. 8, a point indicated by a cross indicates the beat signal at the sampling point. In addition, a solid-line circle indicates a reference signal rpₗ represented by the following Expression (14), and a dotted-line circle indicates a reference signal rqₗ represented by the following Expression (15).

$$[ Math . 9 ]$$

$${rp}_{l} = cos \{ 2 π ( \frac{l}{M} ) \} \qquad ( 14 )$$

$${rq}_{l} = cos \{ 2 π ( \frac{l + 0.5}{M} ) \} \qquad ( 15 )$$

It is possible to classify the beat signal yk at the time k as follows by using the reference signal rpₗ and the reference signal rqₗ.

| if (rpₗ₋₁ ≥ yk > rqₗ₋₁) | //down |
|---|---|
| { | |
| cond = 2; | |
| } | |
| else if (rqₗ₋₁ ≥ yk > rqₗ) | //down |
| { | |
| if (yk < rpₗ₊₁) | cond = 0; |
| else | cond = 1; |
| } | |
| else if (rqₗ ≥ yk ≥ rpₗ₊₁) | //down |
| { | |
| cond = 3; | |
| } | |
| else if (rpₗ₋₁ ≤ yk < rqₗ₋₁) | //up |
| { | |
| cond = 2; | |
| } | |
| else if (rqₗ₋₁ ≤ yk < rqₗ) | //up |
| { | |
| if (yk ≥ rpₗ₊₁) | cond = 0; |
| else | cond = 1; |

}
else //up
{
cond = 3;
}

The signal processor 40 may calculate a phase error pek on the time axis by using a value of “cond” determined as described above and the following Expressions (16) to (19). The signal processor 40 calculates the phase error pek, and stores the correction signal S4 indicating the phase error pek in the storage 55.

$$[ Math . 10 ]$$

$$\begin{matrix}if ( cond = 0 ) & {pe}_{k} = \frac{{y}_{k} - {rp}_{l}}{2 ( {rq}_{l} - {rp}_{l} )}\end{matrix} \qquad ( 16 )$$

$$\begin{matrix}else if ( cond = 1 ) & {pe}_{k} = \frac{{y}_{k} - {rp}_{l}}{2 ( {rp}_{l} - {rq}_{l - 1} )}\end{matrix} \qquad ( 17 )$$

$$\begin{matrix}else if ( cond = 2 ) & {pe}_{k} = \frac{{y}_{k} - {rp}_{l - 1}}{2 ( {rq}_{l - 1} - {rp}_{l - 1} )} - 1.\end{matrix} \qquad ( 18 )$$

$$\begin{matrix}else & {pe}_{k} = \frac{{y}_{k} - {rp}_{l + 1}}{2 ( {rp}_{l + 1} - {rq}_{l} )} + 1.\end{matrix} \qquad ( 19 )$$

In a case of performing the pre-distortion operation, the signal processor 40 causes the correction signal S4 stored in the storage 55 to be outputted to the adder 62 via the switch SW2 and the adder 61 illustrated in FIG. 1. The adder 62 adds up a value (+1 or −1) of the output signal of the setter 75 and the value of the correction signal S4, and generates the signal S11 that is a digital signal indicating the added value. Addition of the correction signal S4 allows for generation of the signal S1 corrected on the basis of the phase error of the beat signal, and the signal S12 generated with use of the corrected signal S1 is outputted to the DA converter 85.

The DA converter 85 converts the signal S12 adjusted on the basis of the phase error into an analog signal, and outputs the generated voltage signal V1 to the light source unit 10. The light source unit 10 performs the frequency modulation of the optical signal that is the laser light on the basis of the voltage signal V1.

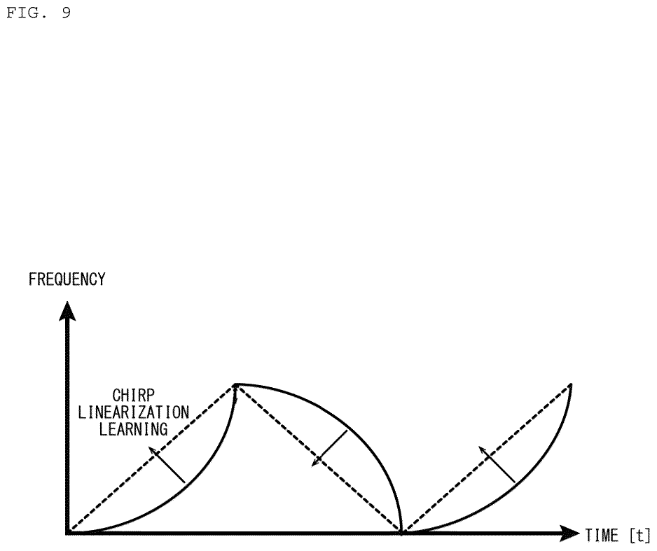

It is thus possible for the distance measurement apparatus 1 to so perform the pre-distortion operation as to reduce the phase error. As in an example illustrated in FIG. 9, chirp linearization learning is performed on the basis of ILC by the signal processor 40, the storage 55, etc., to allow for an appropriate correction of the chirp rate.

In the distance measurement apparatus 1, the voltage signal V1 varies on the basis of the correction signal S4, and the frequency modulation amount of the optical signal of the light source unit 10 is adjusted. It is possible to so correct the frequency modulation amount of the optical signal as to allow the frequency of the optical signal to vary linearly and continuously. This makes it possible to suppress degradation of the frequency modulation characteristic of the optical signal and to improve the distance measurement accuracy.

### Working and Effects

The distance measurement apparatus (the distance measurement apparatus 1) according to the present embodiment includes a light source unit (the light source unit 10), a detector (the detector 20), an AD converter (the AD converter 30), a signal processor (the signal processor 40), a storage (the storage 55), and a controller (the controller 90). The light source unit (the light source unit 10) is configured to output an optical signal subjected to a frequency modulation. The detector (the detector 20) is configured to detect a beat signal based on the optical signal and the optical signal delayed. The AD converter (the AD converter 30) is configured to sample the beat signal at each of sampling points and to perform an AD conversion. The signal processor (the signal processor 40) is configured to generate a first signal (e.g., the correction signal S4) on the basis of the beat signal converted into a digital signal. The first signal (e.g., the correction signal S4) is regarding a correction amount of a frequency of the optical signal. The storage (the storage 55) is configured to allow a plurality of first signals corresponding to a plurality of respective sampling points to be stored in the storage (the storage 55). The controller (the controller 90) is configured to control the frequency modulation of the optical signal on the basis of the first signal stored in the storage.

The distance measurement apparatus 1 according to the present embodiment includes the storage 55 and the controller 90. The storage 55 is configured to allow the plurality of correction signals S4 corresponding to the plurality of respective sampling points to be stored in the storage 55. The controller 90 is configured to control the frequency modulation of the optical signal on the basis of the correction signal S4. Accordingly, in the present embodiment, it is possible to suppress degradation of the frequency modulation characteristic of the optical signal. It is possible to achieve a distance measurement apparatus that makes it possible to improve the frequency modulation characteristic. It is possible to appropriately correct the chirp rate by pre-distortion based on the memory-learning-type ILC, and to improve the distance measurement performance.

The signal processor 40 according to the present embodiment is configured to generate the first signal (e.g., the correction signal S3) on the basis of the beat signal at each of the sampling points and the reference signal. Accordingly, in the present embodiment, it is possible to perform the OPLL operation with use of the correction signal S3, and to appropriately correct the frequency modulation amount of the optical signal. It is possible to achieve a distance measurement apparatus that makes it possible to improve the frequency modulation characteristic. It is possible to suppress degradation of the frequency modulation characteristic of the optical signal, and to improve the distance measurement performance.

The AD converter 30 is configured to sample the beat signal at the frequency of integral multiple of the frequency of the beat signal, and to perform the AD conversion. Accordingly, it is possible to prevent the tracking operation by the PLL from being inappropriately performed due to the reduced sampling points. It is possible for the distance measurement apparatus 1 to suppress degradation of the frequency modulation characteristic of the optical signal.

Even in a case where the delay time τ_{MZI} of the interference unit 15 is small, and a chirp band width Δf (a modulation range of the chirp frequency) is small, it is possible to perform the OPLL operation and to appropriately correct the chirp rate. Accordingly, it is possible to achieve a reduction in device size (reduction in size of the interference unit 15, the light source unit 10, etc.). For example, the distance measurement apparatus 1 may be so configured that the delay time τ_{MZI} of the interference unit 15 is 3 ns or less, and the chirp band width Δf of the optical signal of the light source unit 10 is 1 GHz or less. In this case also, it is possible to prevent the tracking operation by the OPLL from being inappropriately performed, and to suppress a decrease in the distance measurement performance.

### 2. Modification Examples

In the embodiment described above, the configuration example of the distance measurement apparatus 1 has been described. However, it is merely an example, and the configuration of the distance measurement apparatus 1 is not limited to the example described above. For example, the distance measurement apparatus 1 may be configured to perform only one of the OPLL operation and the pre-distortion operation described above. Alternatively, for example, the distance measurement apparatus 1 may turn on the switch SW1 and the switch SW2 together, and to perform both the OPLL operation and the pre-distortion operation at the same time (in parallel). In this case, the distance measurement apparatus 1 may add up, by the adder 61, the correction signal S3 and the correction signal S4, and may correct the frequency modulation amount on the basis of the added correction signals.

### 3. Application Examples

The technique according to the present disclosure is applicable to various circuits and various apparatuses. The distance measurement apparatus 1, the signal processor 40, etc. described above are usable in various apparatuses and various circuits that perform distance measurement. The technique according to the present disclosure is applicable to various products, for example, as various distance measurement apparatuses, various photodetection apparatuses configured to detect incident light, various signal processing apparatuses, etc.

A photodetection apparatus according to an embodiment of the present disclosure includes a detector (the detector 20), an AD converter (the AD converter 30), a signal processor (the signal processor 40), a storage (the storage 55), and a controller (the controller 90). The detector (the detector 20) is configured to detect a beat signal based on an optical signal and the optical signal delayed. The optical signal is outputted from a light source unit (the light source unit 10) and subjected to a frequency modulation. The AD converter (the AD converter 30) is configured to sample the beat signal at each of sampling points and to perform an AD conversion. The signal processor (the signal processor 40) is configured to generate a first signal (e.g., the correction signal S4) on the basis of the beat signal converted into a digital signal. The first signal (e.g., the correction signal S4) is regarding a correction amount of a frequency of the optical signal. The storage (the storage 55) is configured to allow a plurality of first signals corresponding to a plurality of respective sampling points to be stored in the storage (the storage 55). The controller (the controller 90) is configured to control the frequency modulation of the optical signal on the basis of the first signal stored in the storage. This makes it possible to suppress degradation of the frequency modulation characteristic of the optical signal. It is possible to achieve a photodetection apparatus that makes it possible to improve the frequency modulation characteristic.

A signal processing apparatus according to an embodiment of the present disclosure includes a detector (the detector 20), an AD converter (the AD converter 30), a signal processor (the signal processor 40), a storage (the storage 55), and a controller (the controller 90). The detector (the detector 20) is configured to detect a beat signal based on an optical signal and the optical signal delayed. The optical signal is outputted from a light source unit (the light source unit 10) and subjected to a frequency modulation. The AD converter (the AD converter 30) is configured to sample the beat signal at each of sampling points and to perform an AD conversion. The signal processor (the signal processor 40) is configured to generate a first signal (e.g., the correction signal S4) on the basis of the beat signal converted into a digital signal. The first signal (e.g., the correction signal S4) is regarding a correction amount of a frequency of the optical signal. The storage (the storage 55) is configured to allow a plurality of first signals corresponding to a plurality of respective sampling points to be stored in the storage (the storage 55). The controller (the controller 90) is configured to output a signal (e.g., the voltage signal V1) to control the frequency modulation of the optical signal on the basis of the first signal stored in the storage. This makes it possible to suppress degradation of the frequency modulation characteristic of the optical signal. It is possible to achieve a signal processing apparatus that makes it possible to improve the frequency modulation characteristic.

Although the present disclosure has been described above with reference to the embodiment and the modification examples, the present technology is not limited to the above-described embodiments and the like, and various modifications may be made. For example, although the foregoing modification examples have been described as modification examples of the foregoing embodiment, the respective configurations of the modification examples may be combined as appropriate.

Note that the effects described herein are mere examples and the description thereof is non-limiting. Other effects may also be achieved. In addition, the present disclosure may have any of the following configurations.

(1)

A distance measurement apparatus including:
a light source unit configured to output an optical signal subjected to a frequency modulation;
a detector configured to detect a beat signal based on the optical signal and the optical signal delayed;
an AD converter configured to sample the beat signal at each of sampling points and to perform an AD conversion;
a signal processor configured to generate a first signal on the basis of the beat signal converted into a digital signal, the first signal being regarding a correction amount of a frequency of the optical signal;
a storage configured to allow a plurality of first signals corresponding to a plurality of respective sampling points to be stored in the storage; and
a controller configured to control the frequency modulation of the optical signal on the basis of the first signal stored in the storage.
   (2)

The distance measurement apparatus according to (1) described above, in which the signal processor is configured to generate each of the plurality of first signals corresponding to the plurality of respective sampling points on the basis of the beat signal, at each of the sampling points, converted into the digital signal.

(3)

The distance measurement apparatus according to (1) or (2) described above, in which the signal processor is configured to generate the first signal on the basis of a difference between the beat signal in a first modulation period and the beat signal in a second modulation period.

(4)

The distance measurement apparatus according to any one of (1) to (3) described above, in which the signal processor is configured to generate, as the first signal, a signal regarding a frequency error of the beat signal.

(5)

The distance measurement apparatus according to any one of (1) to (4) described above, in which the signal processor is configured to generate, as the first signal, a signal regarding a difference in a phase error of the beat signal.

(6)

The distance measurement apparatus according to any one of (1) to (5) described above, in which the storage includes memories corresponding in number to the plurality of sampling points, and is configured to allow the plurality of first signals corresponding to the plurality of respective sampling points to be stored in the storage.

(7)

The distance measurement apparatus according to any one of (1) to (6) described above, in which the AD converter is configured to sample the beat signal at a frequency that is integral multiple of a frequency of the beat signal, and to perform the AD conversion.

(8)

The distance measurement apparatus according to any one of (1) to (7) described above, in which the signal processor is configured to generate the first signal on the basis of the beat signal at each of the sampling points and a reference signal.

(9)

The distance measurement apparatus according to (8) described above, in which the signal processor is configured to generate, as the first signal, a signal regarding a phase error between the beat signal and the reference signal.

(10)

The distance measurement apparatus according to (8) or (9) described above, in which the signal processor is configured to generate the reference signal on the basis of the beat signal at each of the sampling points.

(11)

The distance measurement apparatus according to any one of (8) to (10) described above, in which the signal processor is configured to perform a comparison between the beat signal and a plurality of reference signals, and to generate the first signal regarding a difference between the reference signal selected on the basis of a result of the comparison and the beat signal.

(12)

The distance measurement apparatus according to any one of (1) to (11) described above, further including a sampler configured to downsample the beat signal outputted from the AD converter.

(13)

The distance measurement apparatus according to (12) described above, in which the signal processor is configured to generate the first signal on the basis of the beat signal downsampled by the sampler.

(14)

The distance measurement apparatus according to any one of (1) to (13) described above, further including an offset corrector configured to perform an offset correction of the beat signal.

(15)

The distance measurement apparatus according to (14) described above, in which the signal processor is configured to generate the first signal on the basis of the beat signal corrected by the offset corrector.

(16)

The distance measurement apparatus according to any one of (1) to (15) described above, further including a gain corrector configured to perform a gain correction of the beat signal.

(17)

The distance measurement apparatus according to (16) described above, in which the signal processor is configured to generate the first signal on the basis of the beat signal corrected by the gain corrector.

(18)

The distance measurement apparatus according to any one of (1) to (17) described above, in which the distance measurement apparatus includes an FMCW distance measurement apparatus.

(19)

A photodetection apparatus including:
a detector configured to detect a beat signal based on an optical signal and the optical signal delayed, the optical signal being outputted from a light source unit and subjected to a frequency modulation;
an AD converter configured to sample the beat signal at each of sampling points and to perform an AD conversion;
a signal processor configured to generate a first signal on the basis of the beat signal converted into a digital signal, the first signal being regarding a correction amount of a frequency of the optical signal;
a storage configured to allow a plurality of first signals corresponding to a plurality of respective sampling points to be stored in the storage; and
a controller configured to control the frequency modulation of the optical signal on the basis of the first signal stored in the storage.
   (20)

A signal processing apparatus including:
a detector configured to detect a beat signal based on an optical signal and the optical signal delayed, the optical signal being outputted from a light source unit and subjected to a frequency modulation;
an AD converter configured to sample the beat signal at each of sampling points and to perform an AD conversion;
a signal processor configured to generate a first signal on the basis of the beat signal converted into a digital signal, the first signal being regarding a correction amount of a frequency of the optical signal;
a storage configured to allow a plurality of first signals corresponding to a plurality of respective sampling points to be stored in the storage; and
a controller configured to output a signal to control the frequency modulation of the optical signal on the basis of the first signal stored in the storage.

The present application claims the benefit of Japanese Priority Patent Application JP2022-170337 filed with the Japan Patent Office on Oct. 25, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A distance measurement apparatus comprising:
a light source unit configured to output an optical signal subjected to a frequency modulation;
a detector configured to detect a beat signal based on the optical signal and the optical signal delayed;
an AD converter configured to sample the beat signal at each of sampling points and to perform an AD conversion;
a signal processor configured to generate a first signal on a basis of the beat signal converted into a digital signal, the first signal being regarding a correction amount of a frequency of the optical signal;
a storage configured to allow a plurality of the first signals corresponding to a plurality of the respective sampling points to be stored in the storage; and
a controller configured to control the frequency modulation of the optical signal on a basis of the first signal stored in the storage.

2. The distance measurement apparatus according to claim 1, wherein the signal processor is configured to generate each of the plurality of first signals corresponding to the plurality of respective sampling points on a basis of the beat signal, at each of the sampling points, converted into the digital signal.

3. The distance measurement apparatus according to claim 1, wherein the signal processor is configured to generate the first signal on a basis of a difference between the beat signal in a first modulation period and the beat signal in a second modulation period.

4. The distance measurement apparatus according to claim 1, wherein the signal processor is configured to generate, as the first signal, a signal regarding a frequency error of the beat signal.

5. The distance measurement apparatus according to claim 1, wherein the signal processor is configured to generate, as the first signal, a signal regarding a difference in a phase error of the beat signal.

6. The distance measurement apparatus according to claim 1, wherein the storage includes memories corresponding in number to the plurality of sampling points, and is configured to allow the plurality of first signals corresponding to the plurality of respective sampling points to be stored in the storage.

7. The distance measurement apparatus according to claim 1, wherein the AD converter is configured to sample the beat signal at a frequency that is integral multiple of a frequency of the beat signal, and to perform the AD conversion.

8. The distance measurement apparatus according to claim 7, wherein the signal processor is configured to generate the first signal on a basis of the beat signal at each of the sampling points and a reference signal.

9. The distance measurement apparatus according to claim 8, wherein the signal processor is configured to generate, as the first signal, a signal regarding a phase error between the beat signal and the reference signal.

10. The distance measurement apparatus according to claim 8, wherein the signal processor is configured to generate the reference signal on a basis of the beat signal at each of the sampling points.

11. The distance measurement apparatus according to claim 8, wherein the signal processor is configured to perform a comparison between the beat signal and a plurality of the reference signals, and to generate the first signal regarding a difference between the reference signal selected on a basis of a result of the comparison and the beat signal.

12. The distance measurement apparatus according to claim 8, further comprising a sampler configured to downsample the beat signal outputted from the AD converter.

13. The distance measurement apparatus according to claim 12, wherein the signal processor is configured to generate the first signal on a basis of the beat signal downsampled by the sampler.

14. The distance measurement apparatus according to claim 1, further comprising an offset corrector configured to perform an offset correction of the beat signal.

15. The distance measurement apparatus according to claim 14, wherein the signal processor is configured to generate the first signal on a basis of the beat signal corrected by the offset corrector.

16. The distance measurement apparatus according to claim 1, further comprising a gain corrector configured to perform a gain correction of the beat signal.

17. The distance measurement apparatus according to claim 16, wherein the signal processor is configured to generate the first signal on a basis of the beat signal corrected by the gain corrector.

18. The distance measurement apparatus according to claim 1, wherein the distance measurement apparatus comprises an FMCW distance measurement apparatus.

19. A photodetection apparatus comprising:
a detector configured to detect a beat signal based on an optical signal and the optical signal delayed, the optical signal being outputted from a light source unit and subjected to a frequency modulation;
an AD converter configured to sample the beat signal at each of sampling points and to perform an AD conversion;
a signal processor configured to generate a first signal on a basis of the beat signal converted into a digital signal, the first signal being regarding a correction amount of a frequency of the optical signal;
a storage configured to allow a plurality of the first signals corresponding to a plurality of the respective sampling points to be stored in the storage; and
a controller configured to control the frequency modulation of the optical signal on a basis of the first signal stored in the storage.

20. A signal processing apparatus comprising:
a detector configured to detect a beat signal based on an optical signal and the optical signal delayed, the optical signal being outputted from a light source unit and subjected to a frequency modulation;
an AD converter configured to sample the beat signal at each of sampling points and to perform an AD conversion;
a signal processor configured to generate a first signal on a basis of the beat signal converted into a digital signal, the first signal being regarding a correction amount of a frequency of the optical signal;
a storage configured to allow a plurality of the first signals corresponding to a plurality of the respective sampling points to be stored in the storage; and
a controller configured to output a signal to control the frequency modulation of the optical signal on a basis of the first signal stored in the storage.
